(19) United States
(12) Patent Application Publication
(10) Pub. No.: US 2010/0006711 A1
(43) Pub. Date: Jan. 14, 2010

(54) FLUID BAG STAND

(76) Inventor: Harvey Roth, Thornhill (CA)

Correspondence Address: Millman IP Inc., 141 Adelaide St. West, Suite 1002, Toronto, ON, CA

(21) Appl. No.: 12/474,918

(22) Filed: May 29, 2009

Related U.S. Application Data
(60) Provisional application No. 61/080,669, filed on Jul. 14, 2008.
(60) Provisional application No. 61/096,411, filed on Sep. 12, 2008.

(51) Int. Cl. F16M 11/22

(52) U.S. Cl. 248/97

(57) ABSTRACT

In a first aspect, the invention is directed to a fluid bag stand for a patient, comprising a pole, a base and at least one bag support. The pole includes a plurality of sections including at least a lower section and an upper section wherein the plurality of sections mate together. The base is mateable with the pole to support the pole in an upright orientation. The at least one bag support is connectable with the pole. The at least one bag support is configured for supporting a fluid bag for a patient.

### FIELD OF THE INVENTION

The present invention relates to a fluid bag stand and more particularly to a fluid bag stand for home use by a patient.

### BACKGROUND OF THE INVENTION

In a typical hospital setting, a fluid bag stand may be provided for holding a fluid bag for a patient who is being provided the fluid (eg. intravenously). Typically, such fluid bag stands are made from metallic materials and are portable by virtue of having casters for rolling along a hospital floor. Traveling between floors of the hospital may be carried out by elevator, thereby reducing the need to lift the fluid bag stand. However, such fluid bag stands may be ill-suited for use in a home setting. Homes are typically not equipped with elevators, and so a patient may be required to lift a fluid bag stand up and down a set of stairs. Additionally, casters may not be well suited to rolling on certain types of carpeting, which may be present in a home setting. Additionally, such fluid bag stands can be relatively expensive particularly for a patient who will only use one for a limited period of time and who will thereafter not need it.

It would be advantageous to provide a fluid bag stand that addresses one or more of the above shortcomings.

### SUMMARY OF THE INVENTION

In a first aspect, the invention is directed to a fluid bag stand for a patient, comprising a pole, a base and at least one bag support. The pole includes a plurality of sections including at least a lower section and an upper section wherein the plurality of sections mate together. The base is mateable with the pole to support the pole in an upright orientation. The at least one bag support is connectable with the pole. The at least one bag support is configured for supporting a fluid bag for a patient.

### BRIEF DESCRIPTION OF THE DRAWINGS

The present invention will now be described by way of example only with reference to the attached drawings, in which:

FIG. 1 is a perspective view of a fluid bag stand in accordance with an embodiment of the present invention;

FIG. 2 is an elevation view of the fluid bag stand shown in FIG. 1 in a disassembled state;

FIG. 3 is a perspective view of a portion of a leg that is a variant of one of the legs of the fluid bag stand shown in FIG. 1;

FIG. 4 is a plan view of a bag support that is part of the fluid bag stand shown in FIG. 1;

FIG. 5 is a sectional side view of the fluid bag stand shown in FIG. 1, with a variant of the legs shown in FIG. 1;

FIG. 6 is a perspective view of the variant of the legs, shown in FIG. 5;

FIG. 7 is a plan view of the fluid bag stand shown in FIG. 1 with a variant of the legs shown in FIGS. 5 and 6; and

FIG. 8 is a plan view of the fluid bag stand shown in FIG. 1 with another variant of the legs shown in FIGS. 5 and 6;

FIG. 9 is a perspective view of a fluid bag stand in accordance with another embodiment of the present invention in an exploded view;

FIG. 10 is a perspective view of the fluid bag stand of FIG. 9 in a tabletop configuration; and

FIG. 11 is a magnified view of a leg and caster from the fluid bag stand of FIG. 9.

### DETAILED DESCRIPTION OF THE INVENTION

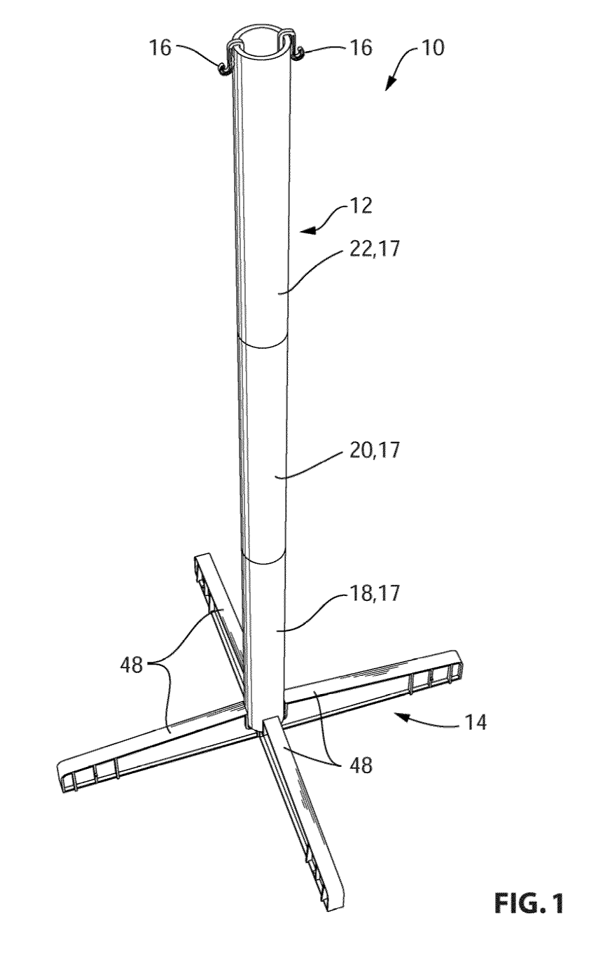

Reference is made to FIG. 1, which shows a fluid bag stand 10 that can be used to hold intravenous fluid bags and the like for a patient. The fluid bag stand 10 may be used by a patient at home or at a patient care facility such as a hospital, nursing home or the like.

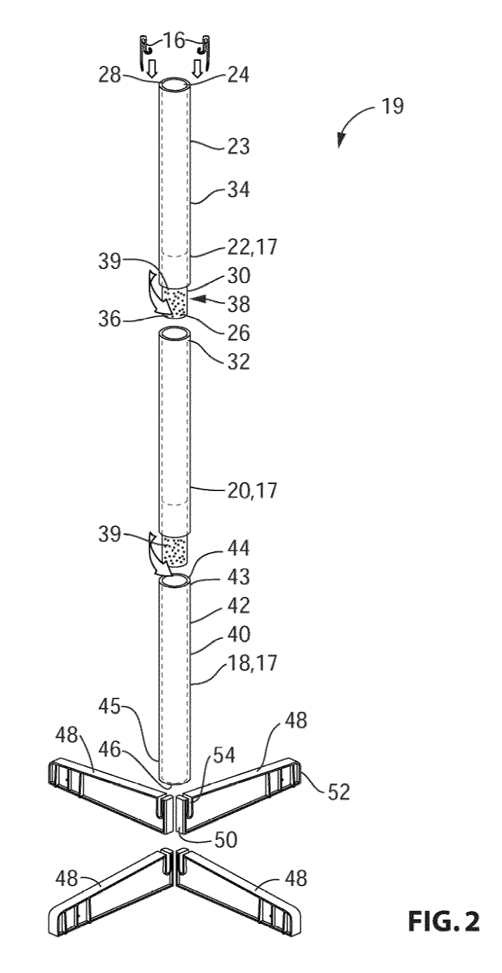

The fluid bag stand 10 includes a pole 12, a base 14 and a plurality of bag supports 16. Reference is made to FIG. 2, which shows the kit of parts 19 from which the stand 10 (FIG. 1) is made. The pole 12 may be made from a plurality of sections 17 including a lower section 18, a middle section 20 and an upper section 22. The upper section 22 has a body 23 and has an upper end 24 and a lower end 26. At the upper end 24 is an upper lip 28 that has an upper lip thickness. The bag supports 16 are configured to be securely mounted onto the lip 28, eg. by means of a press-fit of the bag support 16 onto the lip 28. At the lower end 26 is a downwardly extending tongue 30 that mates with the upper end 32 of the subjacent middle section 20.

The upper section 22 may be formed by a first tube 34 and a second tube 36. The first tube 34 makes up the upper section body 23. The second tube 36 mounts within the first tube 34 and extends downwardly therefrom such that the exposed portion of the second tube 36 forms the downwardly extending tongue 30. A suitable adhesive may be used to adhere the mating surfaces of the first and second tubes 34 and 36. The outer surface of the exposed portion of the second tube 36 that makes up the tongue 30 is shown at 38 and may be provided with dimples 39 thereon to assist in forming a secure joint with the upper end 32 of the middle section 20 when the tongue 30 is press fit into the upper end 32 of the middle section 20. The dimples 39 may be provided by any suitable means, such as by knurling. The dimples 39 may be oriented to form a helical pattern on the surface 38, as shown in FIG. 2. As a result, the upper section 22 may be fit into the middle section 20 by rotating the upper section 22 relative to the middle section in a first selected rotational sense, shown at 40. To remove the upper section 30 from the middle section 20 the upper section 30 may be rotated in an opposing rotational sense to that used to fit the upper section 22 onto the middle section 20.

The middle section 20 may be identical to the upper section 22 and may thus be equally configured to hold the bag supports 16 in the event that it is desired for the pole 12 to stand only as high as two sections 17, perhaps for use as a floor stand for a fluid bag for a child patient.

The lower section 18 may be similar to the upper and middle sections 22 and 20, but may lack a downwardly extending tongue. The lower section 18 may comprise only a first tube 40 which makes up a lower section body 42. The upper end of the lower section is shown at 43 and includes an upper lip 44. The upper lip 44 may be identical to the upper lip 28 so that the bag supports 16 may be mounted on the lower section in the event that it is desired for the pole 12 to stand only as high as the lower section 18, eg. for use as a table stand for a fluid bag for a patient. The lower end of the lower section body 42 is shown at 45 and includes a lower lip 46 that has a lower lip thickness.

It will be understood that the pole 12 may include more than one middle section 20. For example, the pole 12 may optionally include two or more middle sections 20.

The sections 17 may each have a length that is less than approximately 24 inches long.

The sections 17 may each be made from a cardboard material, similar to poster tubes, and may further be coated with a water-resistant coating to inhibit damage from moisture during use.

The base 14 may include a plurality of legs 48 which are individually connectable to the lower lip 46 of the lower section 18. The legs 48 may have any suitable shape and size. For example, the legs 48 may be generally triangular extending radially outwards from the pole 12 (see FIG. 1), and having a larger, radially inner end 50 and a smaller, radially outer end 52. Referring to FIG. 2, proximate the radially inner end 50 each leg 48 may have a slot 54 that mates by press-fit with the lower lip 46 of the lower section 18.

As shown in FIG. 1, there may be four legs 48 which are spaced at 90 degree intervals circumferentially about the pole 12. It will be understood that the base 14 may comprise more or fewer legs than the four legs 48 shown in the figures. For example, the base 14 may comprise two legs. In order to stably support the pole 12, each of the two legs preferably has a more substantial footprint circumferentially about the pole 12 than the legs 48 are shown to have in FIG. 1. Alternatively, the base 14 may comprise a single unitary piece, eg. a circular piece, that mounts to the lower section 18. The legs 48 may be made from any suitable material, such as a polymeric material, such as ABS. Preferably, the legs 48 are made from a recyclable polymeric material.

The legs 48 may have a length of approximately 11 inches.

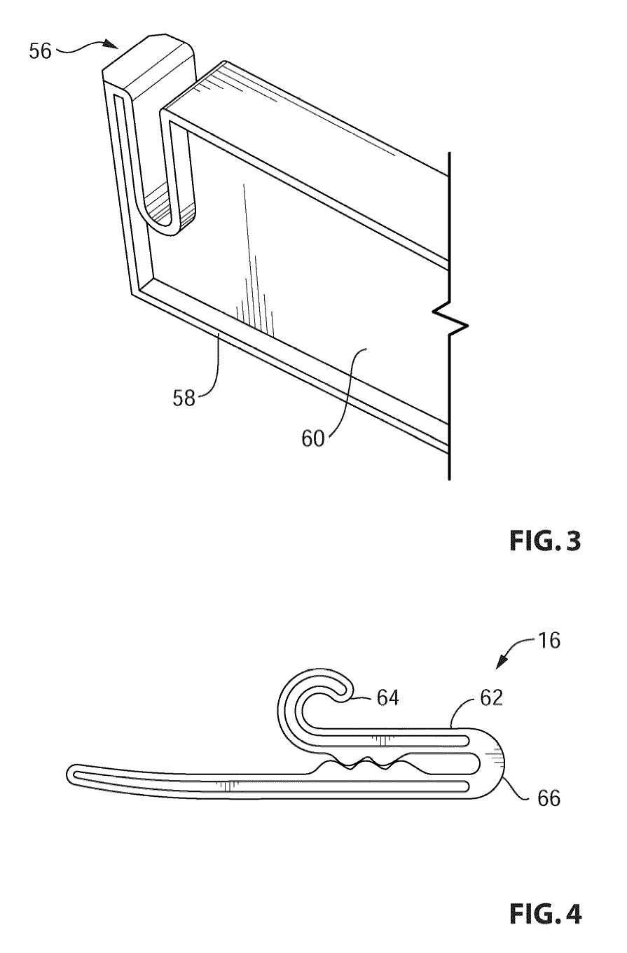

The legs 48 may be made as solid shapes that have a constant cross-sectional shape. Alternatively, as shown in FIG. 3, legs 56 may be provided with a shape that requires less material than that shown in FIG. 1, thereby saving weight and cost, but which function similarly to the legs 48 of FIG. 1. The legs 56 have a peripheral flange portion 58 that surrounds a central web portion 60.

The bag supports 16 may have any suitable shape. For example, referring to FIG. 4, each bag support 16 may have a pole-mounting portion 62 and a bag support portion 64. The pole-mounting portion 62 may comprise a clamp 65 that is configured to mount onto the upper lip 28 of the upper section 22. Since the upper lips of the middle and lower section may be the same as the upper lip 28, the pole-mounting portion 62 may thus be configured to mount to the upper lip of any of the other sections 17 (eg. the middle section 20 and the lower section 18) that make up the pole 12.

The clamp 65 of the bag support 16 may include a plurality of teeth to assist in gripping the upper lip 28 of the upper section 22. The bag support 16 may be provided with a relatively thicker cross section proximate to the hinge of the clamp 65, shown at 66.

The bag support portion 64 may have any suitable shape for holding a fluid bag (not shown). As shown in FIG. 4, the bag support portion 64 may comprise a hook 69 that is sized to fit through an aperture on a fluid bag (not shown). The bag support portion 64 may have any other suitable shape, and may comprises an arm that is angle slightly upwardly, which effectively acts as a hook, but without having a typically-shaped bight. Alternatively, the bag support portion 64 may be configured to support a fluid bag in some other way, such as with an alligator clip.

The bag supports 16 may be made from any suitable material, such as a polymeric material, such as polypropylene.

The bag supports 16 may be relatively small, and may measure less than 4″ long. Thus, all of the components of the fluid bag stand 10 may be less than 24″ long, and may thus fit in a relatively compact box, thereby potentially reducing the cost associated with shipping the box and making the box relatively easy to carry by a single user.

By making the fluid bag stand 10 out of cardboard, and polymeric materials, as shown and described herein, the fluid bag stand 10 may not be suitable for re-use across multiple patients as is typically done in certain settings, such as in a hospital setting. However, the fluid bag stand 10 may be sufficiently inexpensive that it may be considered disposable without representing an inordinate cost burden. Furthermore, the inexpensiveness of the fluid bag stand 10 makes it particularly suited for use in the home of the patient, thereby rendering a large expenditure by the patient unnecessary.

By making the fluid bag stand 10 out of removably connectable sections 17, the fluid bag stand 10 is particularly adapted for conversion from a full-height unit to a unit that is two sections 17 high, to a unit that is one section 17 high.

It will be understood that all of the components of the fluid bag stand 10 mate together and are self-supporting without the need for adhesives or fasteners, thereby facilitating the assembly and disassembly of the fluid bag stand 10.

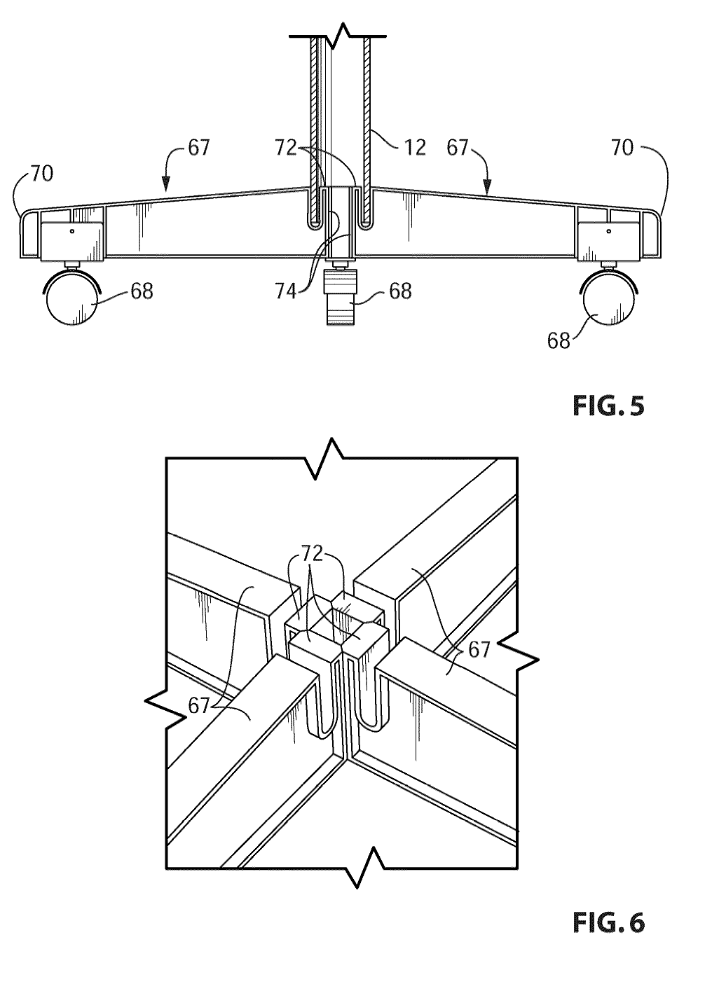

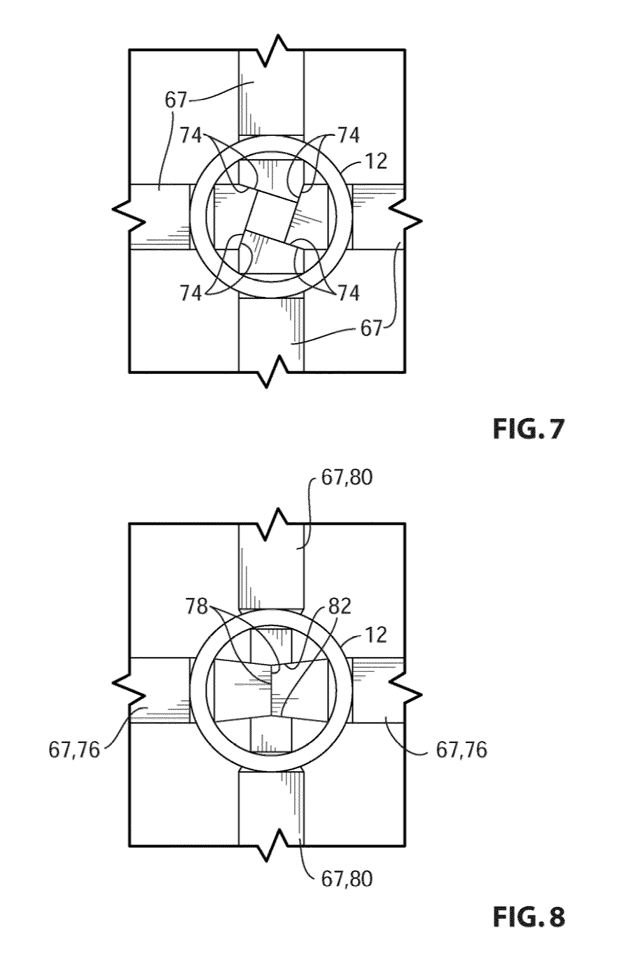

Reference is made to FIGS. 5 and 6. As shown in FIG. 5, it is optionally possible for legs, shown at 67, to be provided that accommodate feet of some kind, such as casters 68. Note that in FIG. 5, only three legs 67 are shown, one leg has been omitted for greater clarity of the figure. In such an embodiment, each caster 68 imposes an upward force on each leg 67, proximate the outer end of the leg 67, shown at 70. At the same time, the pole 12 (shown in section in FIG. 5) and the load imposed thereon by the fluid bag (not shown) exerts a downward force on each leg 67 proximate the inner end of the leg 67, shown at 72. As a result of the forces exerted on the legs 67 by the pole 12 and the casters 68, a moment is exerted on each leg that urges the leg 67 to rotate its outer end 70 upwardly and its inner end 72 downwardly. To inhibit such rotation from taking place, the legs 67 may each be provided with mating surfaces 74 which permit each leg 67 to assist in resisting the rotation of one or more of the other legs 67. The mating surfaces 74 may each generally extend along a vertical plane that is radial relative to the axis of the pole 12. Such a configuration permits all four legs 67 to be identical, thereby permitting them to be manufactured from a single mold. It is alternatively possible to provide other configurations for the mating surfaces of the legs 67 that would nonetheless permit all four legs 67 to be identical. As an example, the mating surfaces 74 may extend along vertical planes that are not radial planes, as shown in FIG. 7. It is also alternatively possible for the legs 67 to be different from each other (see FIG. 8). For example, four legs 67 may be made up of two pairs of legs, a first pair of legs 76 that have vertical mating surfaces 78 that extend vertically and that bisect the pole 12, and a second pair of legs 80 that have mating surfaces 82 that engage the sides of the first pair of legs 76.

It is alternatively possible for the legs 67 to be fitted with some other type of feet instead of casters 68. For example, the feet could be height-adjustable feet to assist the fluid bag stand in resting on an uneven surface.

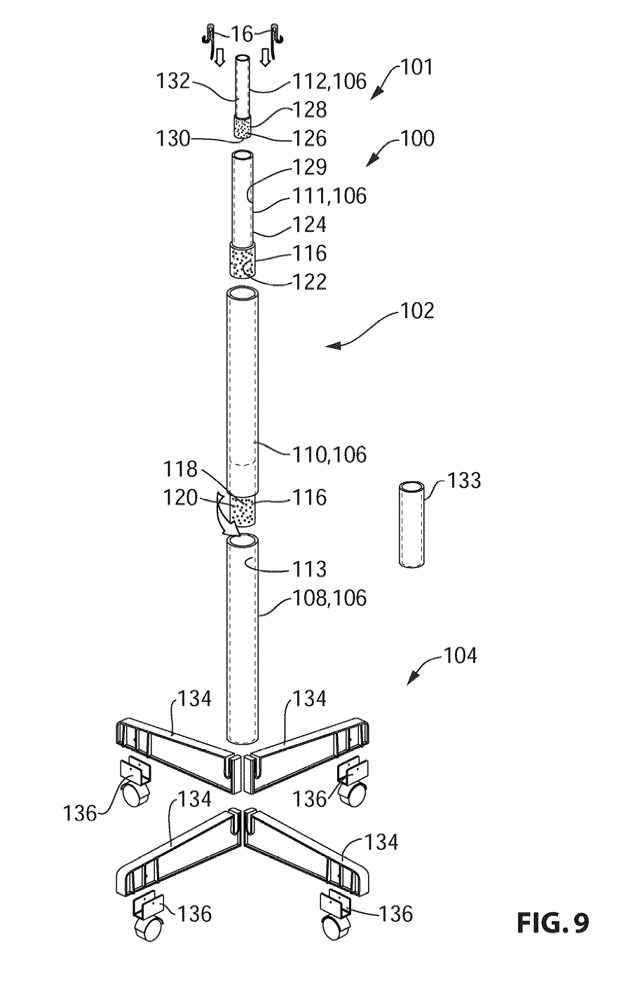

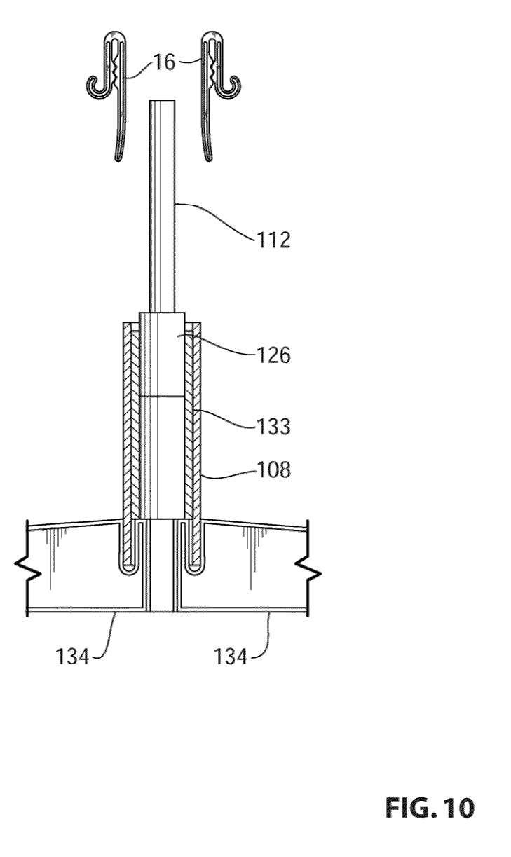

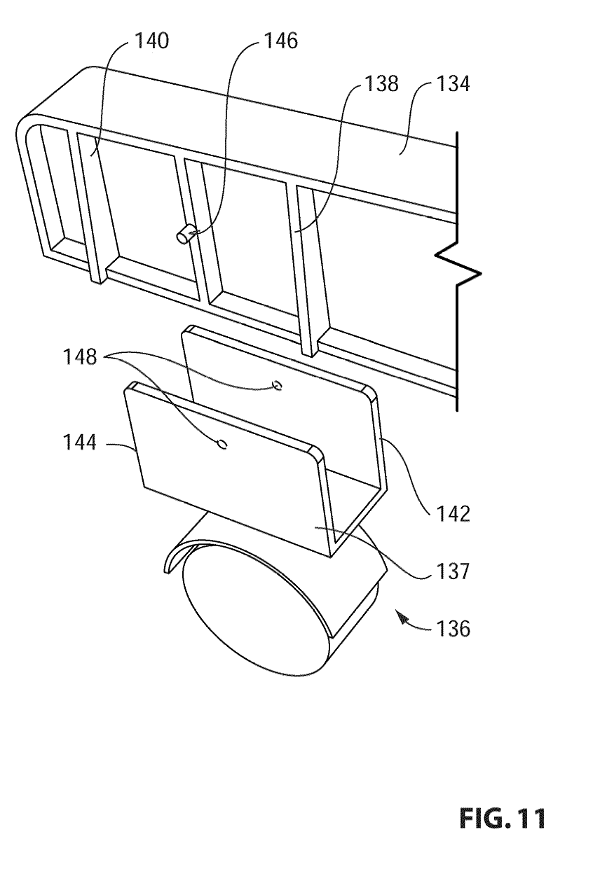

Reference is made to FIG. 9, which shows a kit of parts 100 which is used to make up a fluid bag stand 101 in accordance with another embodiment of the present invention. The fluid bag stand 101 includes a pole 102, a base 104 and a plurality of bag supports 16. The pole 102 may be configurable in a floor mode (FIG. 9) and a tabletop mode (FIG. 10). In the floor mode, the pole 102 is made from a plurality of sections 106 including a lower section 108, a first middle section 110, a second middle section 111 and an upper section 112. The lower section 108 may be similar to the lower section 18 of the pole 12 shown in FIGS. 1 and 2. The lower section 108 may be generally tubular and has an inner surface 113. The first middle section 110 may be generally tubular and has an inner surface 114 that has the same diameter as the lower section. A first joining member 116 joins the first middle section 110 to the lower section 108. The first joining member 116 may be generally tubular and has an outer surface 118 with an outer diameter selected so that it fits snugly within the inner diameters of the first middle section 110 and the lower section 108. The joining member 116 may be permanently joined to the middle section 110 by means of an adhesive or some other joining means.

The exposed portion of the outer surface 118 may be dimpled or otherwise provided with a surface texture that enhances the engagement between it and the inner surfaces of the middle and lower sections 110 and 108. The dimpled surface treatment, shown at 120, may be oriented in a particular direction to act as a rough thread, to facilitate the insertion of the joining member 116 into the lower section 108 by rotating the joining member as it is inserted.

The second middle section 111 may join to the first middle section 110 using a second joining member 116. A difference however, Is that the second joining member 116 may join at its inner surface to the outer surface of the second middle section 111 by means of an adhesive or some other joining means. The inner surface of the second joining member is shown at 122 and the outer surface of the second middle section 111 is shown 124.

The upper section 112 may join to the second middle section 111 using a third joining member 126. The third joining member 126 may be similar to the first and second joining members 116 but may have an outer surface 128 with a diameter to fit snugly within the inner surface (shown at 129) of the second middle section 111, and may have an inner surface 130 sized to fit snugly with the outer surface, shown at 132, of the upper section 112. The third joining member 126 may be adhered or otherwise permanently joined to the upper section 112.

The pole 102 has a tapered appearance which may be preferable for some users. To provide this tapered appearance, however, the third joining member 126 may be smaller in inner and outer diameter than the first and second joining members 116. In the tabletop mode (FIG. 10), the upper section 112 joins directly to the lower section 108 by means of the third joining member 126 and an insert 133 that reduces the effective inner diameter of the lower section 108. The insert has an outer diameter that is similar to the outer diameter of the first joining member 116, and has an inner diameter that is similar to the inner diameter of the second middle section 111.

Referring to FIG. 9, the base 104 is made of legs 134 that may be similar to the legs 67 (FIGS. 5 and 6) and casters 136 that may be similar to casters 68 (FIG. 5). The casters 136 may have a U-shaped sleeve 137 for mounting to the legs 134. In order to hold the casters, the legs 134 may have molded inner and outer ribs 138 and 140 that capture the inner and outer edges 142 and 144 of the sleeve 137 and may further include bosses 146 to engage apertures 148 in the sleeve 137 to prevent the casters 136 from falling off the legs 134 when the stand 101 is picked up.

It will be understood that the fluid bag stand 101 may include more or fewer middle sections, depending on the specific application it is configured for.

All of the pole sections 106, the joining sections 116 and 126, and the insert 132 may be made from simple tubes of cardboard material that are cut to the needed lengths. Additionally, as noted the base 104 is removable from the pole 102 and is itself separable into individual legs 134 and casters 136. The legs 134 are preferably made from molded polymeric material, although selected portions of the casters (eg. the shaft (not shown), and the sleeve 138) may optionally be made from metal or polymer. These aforementioned features combine to provide a reduce the weight of the stand 101 and permit the stand 101 to occupy a relatively small volume when broken down for shipping purposes, thereby reducing the cost for shipping the stand to remote customers. Additionally these features make the stand more usable by the patient, who may find it easier to maneuver the stand 101 relative to some metallic stands of the prior art. Additionally, these features reduce the cost of manufacture of the stand 101 relative to some other fluid bag stands of the prior art. Furthermore, these aforementioned features permit the fluid bag stand to have multiple configurations (eg. floor mode and tabletop mode). Thus, these stands would be particularly applicable for use in certain countries such as some developing countries where it is important to keep the cost of medical care low and where there is a poorly developed local transport infrastructure (eg. dirt roads, small trucks).

While the above description constitutes a plurality of embodiments of the present invention, it will be appreciated that the present invention is susceptible to further modification and change without departing from the fair meaning of the accompanying claims.

1. A kit of parts for a fluid bag stand for a patient, comprising:
a pole, wherein the pole includes a plurality of sections including at least a lower section and an upper section wherein the plurality of sections mate together;
a base, wherein the base is mateable with the pole to support the pole in an upright orientation; and
at least one bag support that is connectable with the pole, wherein the at least one bag support is configured for supporting a fluid bag for a patient.

2. A kit of parts as claimed in claim 1, wherein the pole includes at least one middle section that removably mounts between the lower section and the upper section.

3. A kit of parts as claimed in claim 1, wherein each pole section is tubular and mounts to any adjacent pole sections by means of press fit with a tubular joining member.

4. A kit of parts as claimed in claim 1, wherein each section is made of cardboard tubing.

5. A kit of parts as claimed in claim 4, wherein each section is made of cardboard tubing and mounts to each adjacent section by a press-fit connection.

6. A kit of parts as claimed in claim 4, wherein each section includes a water-resistant outer coating.

7. A kit of parts as claimed in claim 1, wherein the base includes a plurality of legs that are individually mountable to the lower section.

8. A kit of parts as claimed in claim 7, wherein the plurality of legs includes four legs.

9. A kit of parts as claimed in claim 7, wherein the plurality of legs are made from a polymeric material.

10. A kit of parts as claimed in claim 7, wherein each leg includes a radially inner end and includes a slot proximate the radially inner end that is sized to mate as a press-fit with a lower edge of the lower section.

11. A kit of parts as claimed in claim 7, wherein each bag support, each leg and each section is less than a selected length.

10. A kit of parts as claimed in claim 7, wherein each bag support, each leg and each section is less than about 24 inches long.

11. A kit of parts as claimed in claim 1, wherein all but one of the plurality of sections includes a tongue that is press-fittable within an adjacent section.

12. A kit of parts as claimed in claim 1, wherein all sections have an upper end and a lower end and wherein all sections except the lower section include a downwardly extending tongue that is press-fittable within the upper end of any subjacent section and wherein all sections have an upper lip at the upper end wherein the lip has an upper lip thickness wherein all sections have the same lip thickness.

13. A kit of parts as claimed in claim 1, wherein the tongue is dimpled.

14. A kit of parts as claimed in claim 1, wherein the sections are removably connectable together.

15. A kit of parts as claimed in claim 12, wherein the sections are removably connectable together so that the at least one bag support may be positioned on the upper end of the lower section.

16. A kit of parts as claimed in claim 7, wherein the legs each have an inner end and an outer end and each have a foot for engagement with the ground positioned proximate the outer end, and wherein the legs each include at the inner end a mating surface configured to mate with a mating surface on at least one other of the legs to resist rotation of the legs in a vertical plane during use.

17. A kit of parts as claimed in claim 16, wherein the foot is a caster.

18. A kit of parts as claimed in claim 17, wherein the caster is removably mounted to one of the legs.

19. A kit of parts as claimed in claim 18, wherein the caster is captured vertically and horizontally on the leg.

20. A kit of parts as claimed in claim 1, wherein the pole section is configurable in a floor mode and in a tabletop mode.
